(19) United States
(12) Patent Application Publication
(10) Pub. No.: US 2012/0057616 A1
(43) Pub. Date: Mar. 8, 2012

(54) Dynamical/Tunable Electromagnetic Materials and Devices

(75) Inventors: Willie J. Padilla, Los Alamos, NM (US); Richard Averitt, Newton, MA (US)

(73) Assignee: Los Alamos National Security, LLC, Los Alamos, NM (US)

(21) Appl. No.: 13/039,124

(22) Filed: Mar. 2, 2011

Related U.S. Application Data
(63) Continuation of application No. 11/716,257, filed on Mar. 8, 2007, now abandoned.
(60) Provisional application No. 60/780,109, filed on Mar. 8, 2006.

(51) Int. Cl. G01K 7/04; G01J 5/02; B32B 3/00

(52) U.S. Cl. 374/179; 428/195.1; 250/338.1; 374/E07.009

(57) ABSTRACT

A composite material that is responsive to either electromagnetic or thermal radiation. The composite has a controllable structure that is either dynamically or tunably responsive to such radiation and comprises a metamaterial. Sensors, such as a bolometer, that incorporate the composite are also described.

### RELATED APPLICATIONS

This application is a continuation of U.S. patent application Ser. No. 11/716,257 entitled “Dynamical/Tunable Electromagnetic Materials and Devices” filed Mar. 8, 2007, and claims the benefit of Provisional Application Ser. No. 60/780,109 filed Mar. 8, 2006.

### STATEMENT REGARDING FEDERAL RIGHTS

This invention was made with government support under Contract No. DE-AC52-06NA25396, awarded by the U.S. Department of Energy. The government has certain rights in the invention.

### BACKGROUND OF INVENTION

The invention relates to composites that are responsive to either electromagnetic or thermal radiation. More particularly, the invention relates to such responsive composites that comprise metamaterials. Even more particularly, the invention relates to such composites in which the response is controllable.

Metamaterials are artificial materials that exhibit a designed electromagnetic response. Metamaterials have recently generated great interest, due in part to their ability to exhibit an electromagnetic response not readily available in naturally occurring materials. Another advantage of such materials is that resonant structures can be designed over a large portion of the electromagnetic spectrum. Regions in which there is normally no response by naturally occurring materials can thus be targeted for metamaterial applications.

Switching capabilities at different frequencies, ranging from microwave to terahertz (THz), in the electromagnetic spectrum are among the potential applications for metamaterials. Metamaterials that exhibit a controlled, active response, such as dynamic and tunable responses, are desirable.

### SUMMARY OF INVENTION

The present invention meets these and other needs by providing a composite that is responsive to electromagnetic or thermal radiation. The composite has a structure that is dynamically or tunably responsive to such radiation and comprises a metamaterial. Sensors, such as a bolometer, that incorporate the composite are also described.

Accordingly, one aspect of the invention is to provide a sensor that includes: a composite capable of generating an electromagnetic or a thermal signal in response to an electromagnetic stimulus or a thermal stimulus; and either a dielectric substrate upon which the controllable structure is disposed, or a dielectric material within which the composite is embedded. The composite has a structure and comprises a metamaterial with a major dimension that is less than or equal to a predetermined wavelength. The sensor is capable of detecting an optical pulse, a magnetic pulse, a thermal pulse, or an electrical pulse.

A second aspect of the invention is to provide a composite that is capable of generating an electromagnetic or a thermal signal in response to an electromagnetic stimulus or a thermal stimulus. The composite has a structure and is disposed on a dielectric substrate or embedded within a dielectric material. The composite comprises a metamaterial and has a major dimension that is less than or equal to a predetermined wavelength

A third aspect of the invention is to provide a bolometer. The bolometer comprises: a composite capable of generating an electromagnetic or a thermal signal in response to an electromagnetic stimulus or a thermal stimulus; and a temperature sensor in communication with the composite. The composite has a structure and is disposed on a dielectric substrate or embedded in a dielectric material. The composite structure comprises a metamaterial and has a major dimension that is less than or equal to a predetermined wavelength.

These and other aspects, advantages, and salient features of the present invention will become apparent from the following detailed description, the accompanying drawings, and the appended claims.

### BRIEF DESCRIPTION OF THE DRAWINGS

FIG. 1 is a photograph of a focal plane array of split ring resonators;

FIG. 2 is a schematic representation of two artificial “atoms” for metamaterials design;

FIG. 3 is a schematic representation of metamaterial constructs: a) a split ring resonator (SRR) having a double ring structure; b) an electric dipole active structure; c) a composite structure comprising a SRR and a dipole; and d) “active” regions of the SRR shown in FIG. 3a;

FIG. 4 is a schematic representation of: a) a first embodiment of a bolometer; and b) a second embodiment of a bolometer;

FIG. 5 includes: a) frequency dependent transmission spectra; b) the corresponding phase of the transmission; c) calculated surface current at ω₀; and d) calculated surface current at ω₁;

FIG. 6 is a plot of transmission spectra of the magnetic response of split ring resonators (SRRs); and

FIG. 7 includes: a) transmission spectra as a function of photo-doping influence for electric resonance of SRRs; and b) corresponding change of the real dielectric constant of the SRRs as a function of power;

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. In addition, whenever a group is described as either comprising or consisting of at least one of a group of elements and combinations thereof, it is understood that the group may comprise or consist of any number of those elements recited, either individually, or in combination with each other.

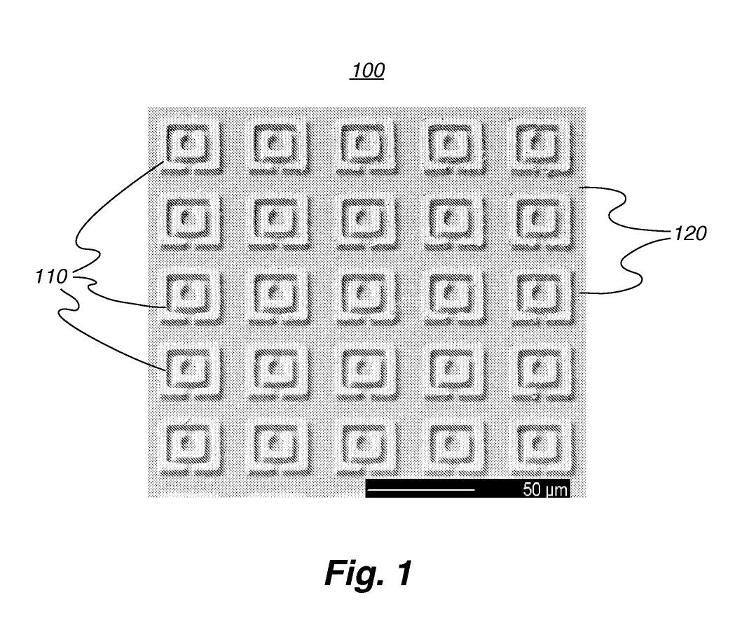

Referring to the drawings in general and to FIG. 1 in particular, it will be understood that the illustrations are for the purpose of describing a particular embodiment of the invention and are not intended to limit the invention thereto.

Turning to FIG. 1, a focal plane array 100 of composites 110 of the present invention is shown. Composites 110 generate an electromagnetic signal or a thermal signal in response to either a thermal stimulus or an electromagnetic stimulus such as, for example, electromagnetic radiation of a selected wavelength, an electric charge, or a potential. Composites 110 have a structure and in the embodiment shown in FIG. 1 are disposed on a surface of a dielectric substrate 120 in the form of an array. In another embodiment, composites 110 are embedded within a dielectric material (not shown).

Dielectric substrate 120, as well as the dielectric material into which the controllable structure may be embedded, may comprise any one of polytetrafluoroethylene (Teflon®), polypropylene, thermoplastic materials, poly(dimethylsiloxane), ferromagnetic materials, functional transition metal oxides, pyroelectric materials, semiconductors, and combinations thereof. Dielectric substrate 120 may be an active substrate such as, for example, gallium arsenide (GaAs) or heterostructures of GaAs such as gallium arsenide/erbium arsenide (GaAs:ErAs). Alternatively dielectric substrate 120 may be a thin film such as a ferroelectric, including, barium titanate (BaTiO₃), strontium titanate (SrTiO₃), lead zirconium titanate-lead lanthanum zirconium titanate (PZT-PLZT), lanthanum strontium titanate, bismuth lanthanum titanate, combinations thereof, and the like.

Composites 110 comprise a metamaterial and, in some embodiments, a dielectric such as those described hereinabove. A metamaterial is an object or collection of objects, arranged in an array, that acquire electromagnetic properties from its structure rather than directly from the materials comprising the metamaterial. The objects or array of objects have features that are comparable to or significantly smaller than the wavelength of the electromagnetic radiation that interacts with the metamaterial. Metamaterials interact with the electromagnetic radiation as would atoms; different units or objects in an array of metamaterials play the role of atomic dipoles, or artificial “atoms.” The metamaterial may comprise highly conductive materials such as, but not limited to, copper, silver, gold, platinum, tungsten, combinations (such as, for example, alloys of these elements) thereof, and the like. Alternatively, the metamaterial may comprise at least one less conductive metal, alloys, and semi-metals such as lead, tin, or brass. Also, the metamaterial may comprise at least one semiconductor such as, but not limited to, silicon and gallium arsenide, where GaAs may be undoped, n-doped, or p-doped. In another embodiment, the metamaterial may comprise at least one of a high temperature superconductor, a low temperature superconductor, magnesium diboride (MgB₂), or conductive transition metal oxides such as rhenium oxide (ReO₃). In yet another embodiment, the metamaterial may comprise at least one of a ferromagnet, an antiferromagnet, or a paramagnet such as, for example, iron difluoride, manganese difluoride, and the like. Conventional photolithographic techniques that are known in the art may be used to form composites 110 on substrate 120.

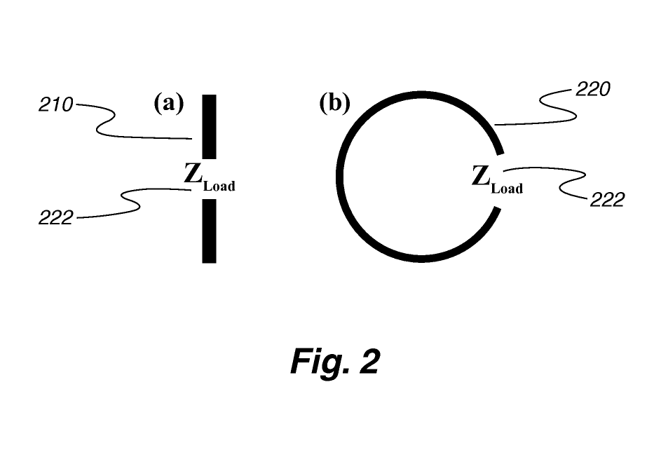

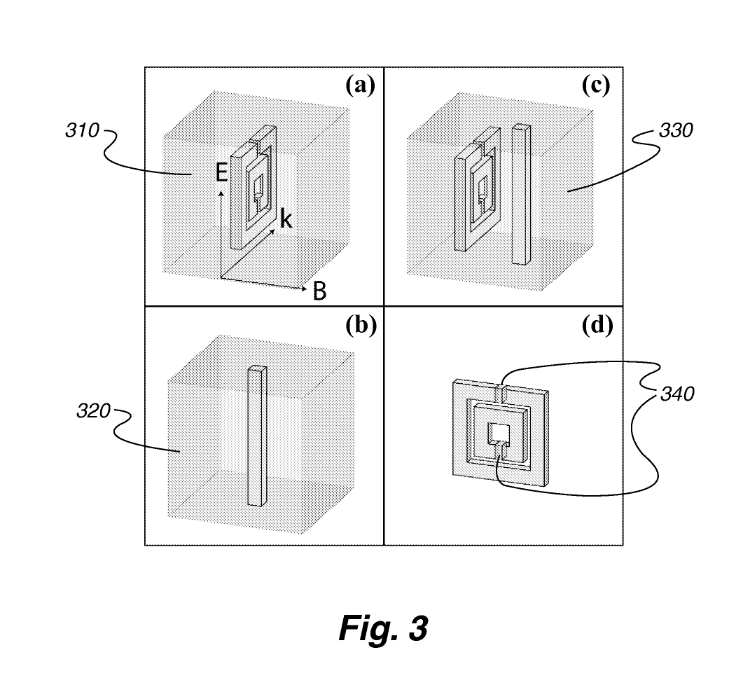

Two artificial “atoms” for metamaterials design are schematically shown in FIG. 2. A straight wire segment 210, which acts as an electric dipole, is shown in FIG. 2a. FIG. 2b shows a wire loop 220, or split ring resonator (also referred to herein as “SRR”), having a gap 222, that acts as a magnetic dipole. A focal plane array 100 of split ring resonators is schematically shown in FIG. 1. Alternatively, the split ring resonator pixels may be arranged in a non-periodic array for interferometric imaging. These SRR pixels may comprise either a single SRR or an array of a plurality of SRRs. The SRRs shown in FIG. 1 have a double ring structure, which provides additional capacitance. Each of these fundamental building blocks is loaded with impedance (Z_{Load}) for two reasons. First, the Z_{Load} allows the SRRs to display resonant behavior at wavelengths (λ) much greater than their dimensions (as with real atoms). Secondly, the appropriate choice of load can lead to tunable behavior. For tunable terahertz metamaterials, semiconductor or materials will be incorporated into the active regions (e.g. 340 in FIG. 3b) of the artificial atoms, thus permitting tuning of the constituent metamaterials with photons, a DC electric field, pressure, magnetic field, electric current, or temperature.

A variety of metamaterial constructs that may be lithographically fabricated are schematically shown in FIG. 3. A split ring resonator 310, having a double ring structure that provides additional capacitance, is shown in FIG. 3a. FIG. 3b shows an electric dipole active structure 320. Planar arrays of SRR 310 (see FIG. 1) and dipole 320 may be fabricated as well. Structures comprising at least one of SRR 310 and at least one of dipole 320 may also be formed (FIG. 3c). “Active” regions 340 of SRR 310 are shown in FIG. 3d.

Each of composites 110 has a major dimension (e.g., length, width, diameter) that that is less than or equal to a predetermined wavelength of radiation. In one embodiment, the predetermined wavelength is in a range from about 1 mm to about 25 nm. In another embodiment, the major dimension is less than or equal to one half of the predetermined wavelength.

A structure of composites 110 may have a controlled dynamic response, a controlled tunable response, or both, to electromagnetic radiation in the range from radio frequencies to near optical frequencies. A dynamic controlled response is one in which the resonance of metamaterials is activated or deactivated (i.e., switched on or off) in a controlled manner. This is accomplished by, for example, photoexcitation of free carriers in substrate 120, which shorts out gap 322 in SRR 220, or by similar processes.

The dynamic controlled response may be switchable over a wide range of predetermined frequencies. In one embodiment, the predetermined frequency is in a range from about 100 Hz to about 500 THz (5×10¹⁴ Hz). In a second embodiment, the predetermined frequency is in a range from about 10⁶ Hz to about 500 Hz. In another embodiment, the predetermined frequency is in a range from about 10⁻⁶ THz to about 500 THz.

A structure of composites 110 may also have a controlled tunable response; the dielectric properties of SRR active region 340 (i.e. the gaps in SRR 310) are modified, which in turn modifies the capacitive loading and hence the resonant response of the magnetic dipole. The host dielectric medium, intra-gap dielectric properties, and semiconducting SRR materials may act as means of controlling the electromagnetic properties of the metamaterials.

The invention also provides a switching device or sensor that includes composites 110, described above. The metamaterials may act as switches for high rate signal processing. The sensor may be capable of far-infrared or thermal imaging and detection.

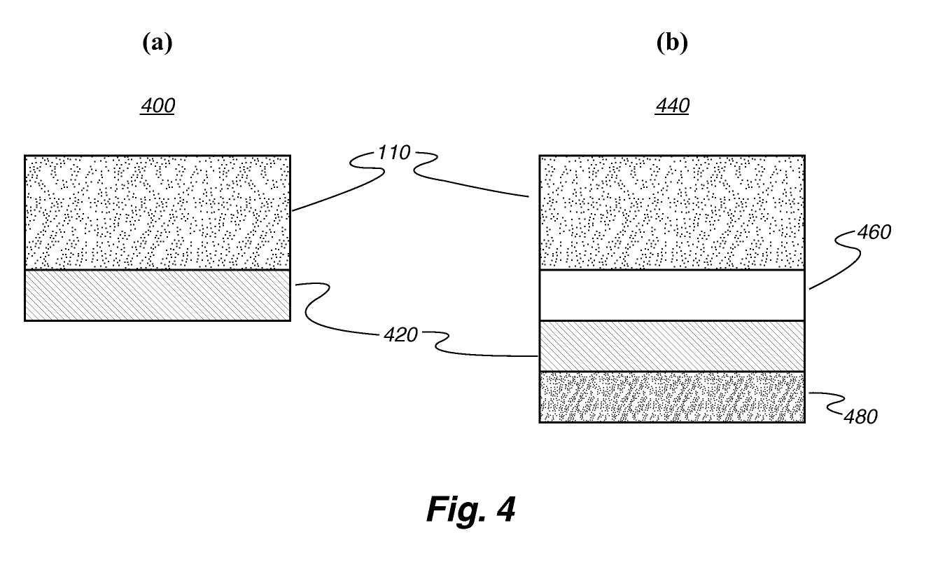

In one embodiment schematically shown in FIG. 4a, the sensor is a bolometer 400. Bolometer 400 comprises composite 110 and a temperature sensor 420 in communication with composite 110. Temperature sensor 420 may be a standard analog or digital surface-mount temperature sensor known in the art such as a thermistor, a thermocouple, or the like. In another embodiment shown in FIG. 4b, bolometer 440 includes thermal link 460 located between composite 110 and temperature sensor 420. Composite 110 communicates with temperature sensor 420 through thermal link 460, which is a layer having a predetermined thickness and comprises at least one material selected from the group consisting of metals, semiconductors, semi-metals, porous silicon, polymers, oligomers, organic-inorganic composites, oxides, borides, carbides, nitrides, silicides, and combinations thereof. For example, thermal link 460 may comprise alumina or zirconia. Bolometer 440 may include a thermal bath 480, which may comprise a heat sink or thermoelectric cooler such as a Peltier device coupled to either composite 110 or temperature sensor 420. Thermal bath 480 dissipates heat from composite 110 and temperature sensor 420. The heat sink may be selected form those known in the art, and may comprise a metal object that is in contact with the object to be cooled. Contact between the heat sink and the object may, in one embodiment, may be made by pressure only, or may be made by means of a gel or other media known in the art to improve thermal conductance.

In one embodiment, composite 110 may be assembled into a focal plane array 100 (FIG. 1) or a pixel (not shown) that is capable of hyperspectral imagery in which frequency information is contained in each pixel. Each pixel acts as a spectrometer and able to record the imaging as a function of frequency, wavelength, or energy.

In another embodiment, composite 110 is arranged in a non-periodic order to provide an interferometric imaging capability. Interferometric imaging uses fewer pixels while providing increased resolution. The pixels are arranged in a pattern and an algorithm is used to convert these points, via Fourier transform, to virtual spatial points, thus providing an increased resolution compared to the actual number of pixels.

The following example illustrates the features and advantages of the invention, and is in no way intended to limit the invention thereto.

### Example 1

Terahertz time domain spectroscopy (THz-TDS) is used to characterize the electromagnetic response of a planar array of SRRs fabricated on semi-insulating gallium arsenide substrate. In addition to characterizing the response of the magnetic (μ(ω)) and electric (∈(ω)) resonances, the example demonstrates the potential for creating dynamic SRR structures that may act as terahertz switches. This is accomplished through photoexcitation of free carriers in the substrate which short out the SRR gap, thereby turning off the electric resonance.

A planar array of SRRs is fabricated from 3 μm thick copper on a 670 μm thick high resistivity gallium arsenide (GaAs) substrate. The outer dimension of an individual SRR is 36 μm, and the unit cell is 50 μm.

Using THz-TDS, the transmitted electric field is measured for the SRR sample and a suitable reference which, in this case, is a bare GaAs substrate.

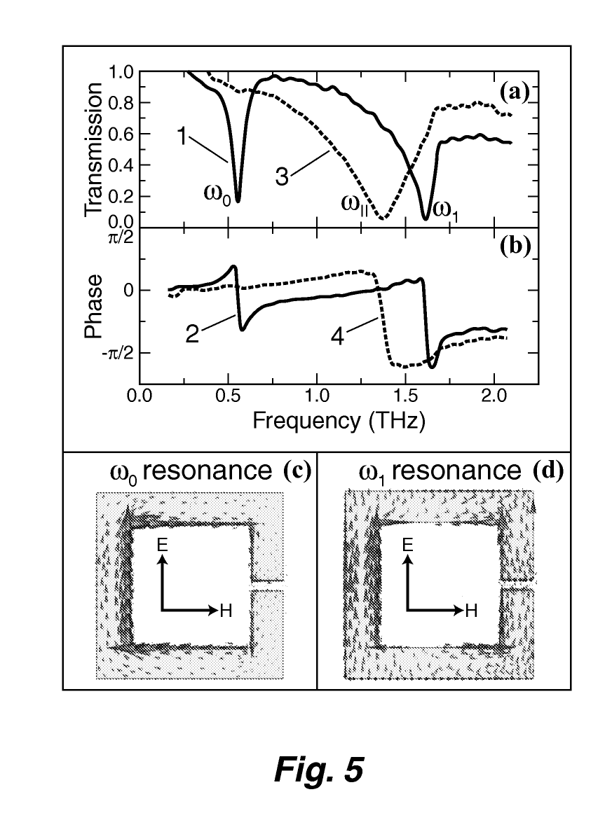

The SRR response without photoexcitation is first considered. The transmission spectra and corresponding phase are shown in FIGS. 5(a) and FIG. 5(b), respectively. Since the measurements are obtained at normal incidence and the magnetic field lies completely in the SRR plane, the measurements focus solely on the electric resonant response. Curves 1 and 2 in FIGS. 5a and 5b represent the response obtained with the electric field (E) oriented as depicted in FIG. 5c (i.e. electric field (E) is perpendicular to the SRR gap). Curves 3 and 4 in FIGS. 5a and 5b represent the response when the electric field is oriented parallel to the SRR gap. At low frequencies, the transmission is high, approaching 95% for both polarizations. With the electric field perpendicular to the SRR gap, a pronounced resonance at ω₀=0.5 THz is observed where the transmission decreases to about 15%. In addition, a second absorption resonance is observed near ω₁=1.6 THz.

Numerical simulations of the SRR response were performed in order to understand the origin of the ω₀ and ω₁ resonances. FIGS. 5c and 5d show the results of the calculated surface currents at ω₀ and ω₁, respectively. The low energy ω₀ THz absorption due to an electric response ∈(ω) of the SRRs occurs at the same frequency as the magnetic μ(ω) resonance, as evidenced by the observation of the circulating currents shown in FIG. 5c. These circulating currents are produced from the incident time-varying electric field, which generates a magnetic field polarized parallel to the surface normal of the SRR. This is not surprising, since SRRs are bianisotropic, meaning that the electric and magnetic responses of the SRR are coupled. In contrast, the higher energy ω₁ resonance at 1.6 THz originates from the half wave resonance due to the side length L=36 μm of the SRR, and is consistent with the calculated surface currents shown in FIG. 5d.

A different electrical resonant behavior is observed when the SRR sample is rotated by 90 degrees such that the electric field E is parallel to the SRR gap, a seen in curves 3 and 4 curves in FIGS. 5a and 5b. A single broad absorption at ω_{∥} is observed in curves 3 and 4 in FIGS. 5a and 5b. Simulations have verified that this resonance is analogous to the ω₁ half-resonance. The red shift and broadening of the ω_{∥} resonance in comparison to the ω₁ resonance is consistent with the fact that there are now two L=36 μm side lengths per unit cell resulting from dipolar coupling along with radiation induced-damping. There is no electric resonance that is analogous to the ω₀ resonance for this orientation; i.e. there is no response with E producing circulating currents with an associated magnetic field directed perpendicular to the GaAs substrate.

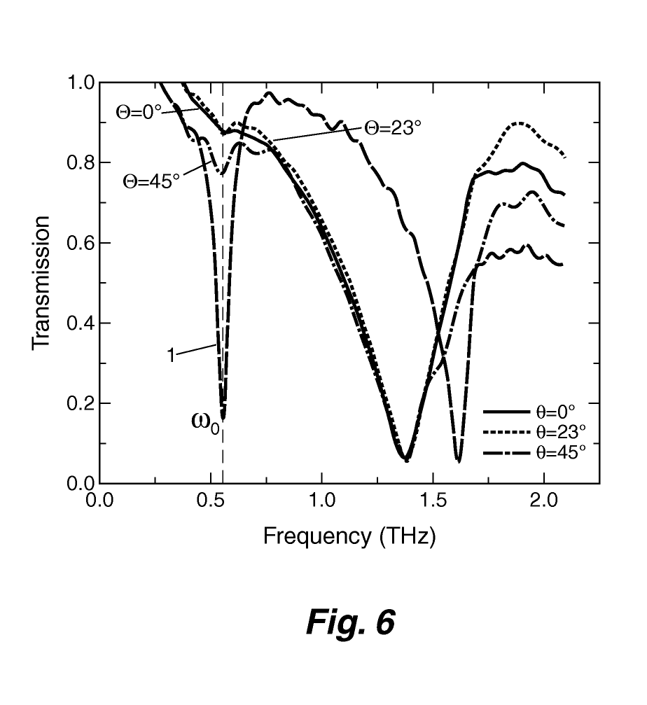

To further investigate the nature of the ω₀ resonance, the SRR response was measured at various angles of incidence. Measurements were performed with the electric field E parallel to the SRR gap (e.g., 222 in FIG. 2b), so that there is no electrically active ω₀ resonance to complicate determination of the μ(ω) response. In particular, the SRR is rotated about an axis parallel to the split gap of the SRR. This permits characterization of the magnetic response of the SRR, since μ(ω) increases for increasing angles with a maximum occurring for Θ=90°. The results for angles of incidence Θ=0°, 23°, and 45° are shown in FIG. 6. The normal incidence data for E perpendicular to the SRR gap (from FIG. 5a) is replotted as a dashed line (curve 1 in FIG. 6) as a reference. For normal incidence (Θ=0°) there is no discernable feature at 0.5 THz. At the incident angle Θ=23°, however, a slight dip begins to develop at ω₀. The magnetic coupling to this mode can be further strengthened by increasing the incident angle. Such coupling is apparent for Θ=45°, where there is a well developed absorption in transmission at approximately 0.5 THz. This behavior is consistent with the development of a resonant μ(ω) response since, with an increasing angle of incidence, a correspondingly larger component of the incident THz magnetic field is projected normal to the plane in of the SRRs (i.e., perpendicular to the GaAs substrate). In addition, as the dashed vertical line in FIG. 6 reveals, the μ(ω) and ∈(ω) response both occur at ω₀, as discussed above. The combined results of FIGS. 5 and 6 provide a fairly complete description of the electromagnetic response of the SRRs in the absence of photoexcitation.

Induced changes in the electric resonant response (i.e., ω₀ and ω₁) following photoexcitation have also been investigated. Since the ω₀ resonance shown in FIG. 5a has been shown to focus strong electric fields within the split gap of the SRR, it is expected that the resonance at ω₀ would strongly depend upon materials placed in or near the gap. The approach used to study the change in resonant response of the SRR is to change the background dielectric of the substrate material as a function of photo-doping. The dielectric function of GaAs is changed dynamically with an optical pulse of about 50 femtosecond (fs) that creates free carriers in the conduction band. The resulting effect on the resonant SRR response is studied as a function of pump power. The pump pulse is timed to arrive 5 picoseconds (ps) before the peak of the THz waveform, thus ensuring that a long-lived carrier density has been established. Since the lifetime of carriers in GaAs is significantly longer than the THz waveform, this allows the quasi-steady state response of the SRRs to be characterized as a function of incident power (i.e., carrier density in the GaAs substrate).

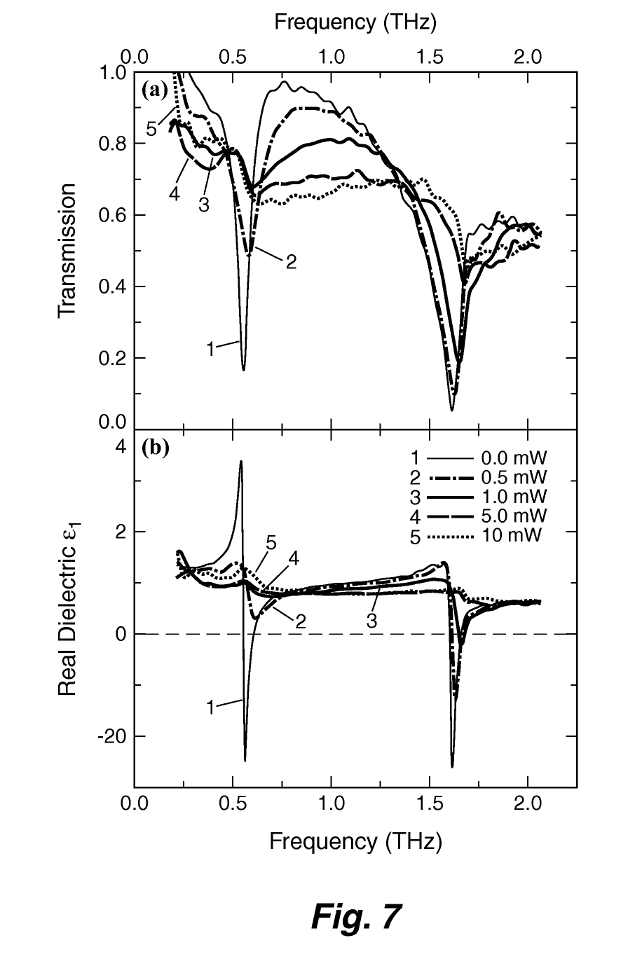

In FIG. 7a the dependence of electric resonances ω₀ and ω₁ on pump power in transmission is shown. Curve 1 in FIG. 7 is the SRR response re-plotted from FIG. 5a; i.e., the electric response of the SRRs at zero pump power. At a pump power of 0.5 mW (curve 2 in FIG. 7), the overall transmission decreases and the strength of the ω₀ resonance significantly weakens. In these experiments, a pump power of 0.5 mW corresponds to a fluence of 1 μJ/cm², which results in a photo-excited carrier density n of about 2×10¹⁶ cm⁻³. While ω₀ is strongly affected by pump powers as small as 0.5 mW, it is interesting to note that ω₁ is not significantly altered. When the pump power is increased to 1 mW (n˜4×10¹⁶ cm⁻³) the low energy resonance ω₀ associated with circulating currents in the SRRs is nearly entirely quenched. In this case, the transmission at ω₀ increases from approximately 15% to over 70%. Further, T(ω) continues to decrease over all frequencies characterized. This is due, in part, to the free carrier response of the photo-excited GaAs. Note that although ωₒ has been short circuited, there is still little change in ω₁. At 5 mW of pump power, T(ω) further decreases and ω₁ finally begins to weaken. The dependence of ω₀ and ω₁ on pump power can be understood by considering the different nature of these two resonances. As previously mentioned, the lower energy resonance is attributed to circulating currents within the SRR. Thus, by providing free charges within the substrate, it becomes possible to short circuit the response and, as the gap in the SRR is relatively small (˜2 μm), only low pump powers are required. However, ω₁ is due to the side length of the SRR and therefore more charges (and thus more power) are required to effectively screen this resonance.

The real part of the dielectric function ∈₁(ω) is displayed in FIG. 7b. This further highlights that, for low excitation densities, the ω₀ resonance completely disappears while the ω₁ survives to slightly higher fluences. For zero pump power, the SRR metamaterials obtain a region of negative ∈(ω) for both the ω₀ and ω₁ resonances. The region of negative ∈ for ω₀ spans from 550 GHz to 600 GHz and reaches a maximum negative value of ∈=−2.5 at ω=560 GHz, while ω₁ spans from 1.6 THz to 1.66 THz and obtains a slightly greater value of ∈=−2.6. For a pump power of 0.5 mW, the ω₀ resonance is reduced greatly and the 531 <0 response destroyed. Thus, one scenario permitting these metamaterials to be used as dynamical devices involves photo-induced band-pass response. A 1 mW pump pulse, if used at ω=560 GHz, where the transmission has a minimum, for example, increases T(ω) by ˜60% and consequently changes the SRR metamaterial medium from absorbing to transparent.

The results shown in FIG. 7 were obtained for SRRs fabricated on intrinsic GaAs substrates. In this case, the recombination time of the carriers in GaAs is greater than 1 nanosecond (ns), meaning that the switched state of the SRR structure (i.e. the photoinduced increase in transmission) is long-lived. It would, however, be possible to fabricate identical SRR structures on gallium arsenide grown at low temperature or GaAs:ErAs semiconductor heterostructures, the latter of which allows for engineered picosecond (1 ps to 10 ps) carrier recombination times. This would enable picosecond on/off switching times of the SRR electric response, thereby enabling optically controlled high frequency modulation of narrow band THz sources. Furthermore, with electrical carrier injection, another possibility would be to create all-electrical THz modulators.

Dynamical control of SRR metamaterials at THz frequencies has been demonstrated. The full characterization of the biaxial electric response of the SRRs has been given, and all expected absorption dips in the spectra have been identified. These are the first results characterizing SRRs using THz-TDS which take full advantage of the ability to measure the electric field amplitude and phase. In addition, through photoexcitation of carriers in the GaAs substrate, control of the main ω₀ resonance associated with both an electric ∈(ω) and magnetic μ(ω) response has been shown. These results indicate the possibility of using SRRs as an active narrowband THz switch.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

We claim:

1. An article of manufacture comprising:
a dielectric substrate, and
a planar array of split ring resonators on the substrate, each split ring resonator comprising double ring structure, each ring of the double ring structure comprised of a material selected from a transition metal and alloy thereof, each ring comprising an active region, the active region being a gap in the ring filled with a material selected from a semiconductor and a ferroelectric material.

2. The article of manufacture of claim 1, wherein the dielectric substrate comprises at least one material selected from the group consisting of polytetrafluoroethylene, polyimide, polypropylene, thermoplastic materials, poly(dimethylsiloxane), ferromagnetic materials, functional transition metal oxides, pyroelectric materials, semiconductors, and combinations thereof.

3. The article of manufacture of claim 1, further including a temperature sensor in communication with the dielectric substrate.

4. The article of manufacture of claim 3, wherein said temperature sensor comprises a thermocouple or thermistor.

5. The article of manufacture of claim 3, further comprising a thermal link in between the dielectric substrate and the temperature sensor, said thermal link comprising a layer of at least one material selected from the group consisting of a metals, semiconductors, semi-metals, porous silicon, polymers, oligomers, organic-inorganic composites, oxides, borides, carbides, nitrides, silicides and combinations thereof.

6. The article of manufacture of claim 3, wherein the transition metal or alloy material of the split ring resonator is selected from copper, silver, gold, platinum, tungsten, and combinations thereof.

7. The article of manufacture of claim 5, further comprising a thermal bath coupled to the structure for dissipating heat from the structure.

8. The article of manufacture of claim 7, wherein said thermal bath is selected from a heat sink and a thermoelectric cooler.

9. A terahertz switch structure comprising:
a dielectric substrate of gallium arsenide, and
a planar array of copper split ring resonators on the substrate, each split ring resonator having a thickness of 3 micrometers and an outer dimension of 36 micrometers and comprising a double ring structure, each ring of the double ring structure comprising a gap of approximately 2 micrometers, wherein said terahertz switch structure behaves as a terahertz switch when said gap is shorted out by a suitable photoexcitation of free carriers in the substrate which turns off an electric resonance of the terahertz switch structure.

10. The structure of claim 9, wherein the dielectric substrate comprises a thickness of 670 micrometers.
